(19) United States
(12) Patent Application Publication
(10) Pub. No.: US 2015/0195812 A1
(43) Pub. Date: Jul. 9, 2015

(54) APPARATUS AND METHOD FOR PROVIDING EMERGENCY SERVICE IN A BROADBAND MOBILE COMMUNICATION SYSTEM

(71) Applicants: Giwon Park, Anyang-si (KR); Youngsoo Yuk, Anyang-si (KR); Yongho Kim, Anyang-si (KR); Kiseon Ryu, Anyang-si (KR)

(72) Inventors: Giwon Park, Anyang-si (KR); Youngsoo Yuk, Anyang-si (KR); Yongho Kim, Anyang-si (KR); Kiseon Ryu, Anyang-si (KR)

(73) Assignee: LG ELECTRONICS INC., Seoul (KR)

(21) Appl. No.: 13/575,022

(22) PCT Filed: Jan. 14, 2011
(86) PCT No.: PCT/KR2011/000290

§ 371 Date: Oct. 17, 2012

Related U.S. Application Data
(60) Provisional application No. 61/297,818, filed on Jan. 25, 2010.

(30) Foreign Application Priority Data
Aug. 30, 2010 (KR) 10-2010-0084406

(51) Int. Cl. H04W 68/00; H04W 4/22

(52) U.S. Cl. CPC H04W 68/005; H04W 4/22

(57) ABSTRACT

Disclosed is a method for providing an emergency service of a terminal in a broadband mobile communication system. A method for receiving an emergency service message of a terminal in an idle mode having a paging cycle comprised of a paging available interval and a paging unavailable interval, includes: receiving a control message including information indicating that an emergency service message was transmitted in the paging available interval and information indicating a point in time at which the emergency service message was transmitted; when the point in time at which the emergency service message was transmitted comes after the paging available interval according to the results of checking the received control message, maintaining an idle mode state until before the emergency service message is received; after a first message including a system parameter is received in the paging unavailable interval, comparing a point in time at which the first message was received and the point in time at which the emergency service message was transmitted to check whether or not they correspond with each other; and when the points in time correspond with each other according to the comparison results, transitioning to a wakeup state from the point in time at which the first message was received, and receiving the emergency service message.

### TECHNICAL FIELD

The present invention relates to a method for receiving an emergency alert message while a terminal in an idle or sleep mode is maintained in the idle or sleep state.

### BACKGROUND ART

Next-generation communication systems have been advanced toward providing a variety of high speed large capacity services to mobile stations (MSs). Representative next-generation generation communication systems include, for example, an IEEE (Institute of Electrical and Electronics Engineers) 802.16 communication system, a Mobile WiMAX (Worldwide Interoperability for Microwave Access), and the like. Here, the mobile WiMAX communication system is a communication system based on an IEEE 802.16 communication system, and the IEEE 802.16 communication system is a communication system using the IEEE 802.16 standard.

An emergency service proposed in the IEEE 802.16 communication system will be described as follows.

In general, emergency services include a wireless emergency rescue service (WERS) and a wireless emergency alert service (WEAS). The WERS and WEAS will be described as follows.

First, the WERS is also called an MS-triggered emergency service (MS-triggered ES), and includes a service supporting a safe rescue by recognizing a location of an MS when an emergency such as, for example, a fire, a crime, or the like, takes place. In the case of WERS, is generally triggered by an MS, so it is called an MS-triggered ES. Types of WERS include a voice call service, such as, a 911 service, or the like.

Second, the WEAS is a BS-triggered emergency service (BS-triggered ES), which includes a service supporting an emergency notification such as storm warning, imminent earthquake and tsunami warning. In the case of the WEAS, since it is generally triggered by a base station, it is called a BS-triggered ES.

In the related art, when an idle or sleep mode terminal receives an emergency alert indication, it is maintained in a listening mode until when an emergency alert message is received. Namely, the terminal operating in the idle mode until when an emergency alert message does not enter a paging unavailable interval, and the terminal operating in the sleep mode does not enter a sleep interval. Thus, a problem in which a power saving effect is reduced arises.

Thus, in the present disclosure, in order to maximize power saving of a terminal, a method for receiving an emergency alert message transmitted from a base station while a terminal is maintained in an idle or sleep state is provided.

### DISCLOSURE

### Technical Problem

Therefore, an object of the present invention is to provide a method and apparatus for providing emergency service information through a control message including information regarding whether or not emergence service information was transmitted and information regarding a point in time at which the emergency service information was transmitted.

### Technical Solution

According to an aspect of the present invention, there is provided a method for receiving an emergency service message of a terminal in an idle mode having a paging cycle comprised of a paging available interval and a paging unavailable interval, including: receiving a control message including information indicating that an emergency service message was transmitted in the paging available interval and information indicating a point in time at which the emergency service message was transmitted; when the point in time at which the emergency service message was transmitted comes after the paging available interval according to the results of checking the received control message, maintaining an idle mode state until before the emergency service message is received; after a first message including a system parameter is received in the paging unavailable interval, comparing a point in time at which the first message was received and the point in time at which the emergency service message was transmitted to check whether or not they correspond with each other; and when the points in time correspond with each other according to the comparison results, transitioning to a wakeup state from the point in time at which the first message was received, and receiving the emergency service message.

The method may further include: after the emergency service message is completely received, operating in the idle mode state before the wakeup.

The first message may be a primary super frame header (P-SFH).

The information indicating the point in time at which the emergency service message was transmitted may indicate a position of a superframe in which the emergency service message is transmitted, and the position of the superframe may be determined according to a value set in a least significant bit (LSB) of a superframe number.

The system parameter may include an LSB of the superframe number in which the first message is transmitted, and in the comparing, an LSB of the superframe included in the system parameter and a value set in an LSB indicating the point in time at which the emergency service message was transmitted may be compared to check whether or not they correspond with each other.

The control message may be a paging advertisement message (AAI_PAG-ADV Message).

The position in which the emergency service message is transmitted may be a subframe or a frame in which the first message is transmitted.

According to another aspect of the present invention, there is provided a method for receiving an emergency service message of a terminal in a sleep mode having a sleep cycle comprised of a listening window and a sleep window, including: receiving a control message including information indicating that an emergency service message was transmitted in the listening window and information indicating a point in time at which the emergency service message was transmitted; when the point in time at which the emergency service message was transmitted comes after the listening window according to the results of checking the received control message, maintaining a sleep mode state until before the emergency service message is received; after a first message including a system parameter is received in the sleep window, comparing a point in time at which the first message was received and the point in time at which the emergency service message was received to check whether or not they correspond with each other; and when the points in time correspond with each other according to the comparison results, transitioning to a wakeup state from the point in time at which the first message was received, and receiving the emergency service message.

The control message may be a data traffic generation indication message or a sleep mode control extended header.

According to another aspect of the present invention, there is provided a terminal for receiving an emergency service message in an idle mode having a paging cycle comprised of a paging available interval and a paging unavailable interval, including: a receiving unit configured to receive a control message including information indicating that an emergency service message was transmitted in the paging available interval and information indicating a point in time at which the emergency service message was transmitted, and receive an emergency service message in the paging unavailable interval; a message interpreting unit configured to detect the point in time at which the emergency service message was transmitted and a point in time at which a first message including a system parameter was received from the paging unavailable interval; and a controller configured to control an operation of the terminal by determining whether or not the point in time at which the emergency service message was transmitted comes after the paging available interval.

The controller may compare the point in time at which the emergency service message was transmitted and the point in time at which the first message was received to check whether or not they correspond with each other, and when the points in time correspond with each other, the controller may provide control to transition to a wakeup state.

### Advantageous Effects

According to embodiments of the present invention, when an emergency service message is transmitted, information regarding a point in time at which the emergency service message was transmitted is transmitted in advance, whereby power consumption of a terminal operating in a sleep mode or an idle mode can be reduced.

### DESCRIPTION OF DRAWINGS

FIG. 1 is a view showing a procedure for receiving an emergency alert message by a terminal according to an embodiment of the present invention of the present disclosure.

FIG. 2 is a view showing a method for transmitting an emergency alert message from a base station to a terminal according to a first embodiment of the present invention of the present disclosure.

FIG. 3 is a view showing a procedure for receiving an emergency alert message by a terminal according to a second embodiment of the present invention of the present disclosure.

FIG. 4 is a view showing a procedure for receiving an emergency alert message by a terminal according to a third embodiment of the present invention of the present disclosure.

FIG. 5 is an internal block diagram of a terminal for receiving emergency alert information according to an embodiment of the present invention of the present disclosure.

### BEST MODES

Reference will now be made in detail to the preferred embodiments of this specification, examples of which are illustrated in the accompanying drawings. It should be understood that the description herein will be given of essential parts required to understand operations according to this specification and description of the other parts will be omitted to obviate obscurity of the point of the invention.

This specification proposes an apparatus and method for providing an emergency service in a communication system, for example, which employs Institute of Electrical and Electronics Engineers (IEEE) 802.16 standard (hereinafter, referred to as 'IEEE 802.16 communication system).

The detailed description will be given of an apparatus and method for providing an emergency service, for example, in the IEEE 802.16 communication system. However, the apparatus and method for providing the emergency service given by the detailed description may also be applicable to other communication systems as well as the IEEE 802.16 communication system.

The exemplary embodiments herein are combinations of components and characteristics in certain forms. Each component or characteristic should be considered to be optional unless being explicitly described. Each component or characteristic may be embodied in the form of non-combination with other components or characteristics. Also, the exemplary embodiments can be implemented by combination of part of components and/or characteristics. The sequence of operations described in the exemplary embodiments may differ. Part of configurations or characteristics in one exemplary embodiment will be included in another exemplary embodiment, or be replaced with corresponding configurations or characteristics in another embodiment.

The exemplary embodiments in this specification are described herein on the basis of relation of data transmission and reception between a base station and a terminal. Here, the base station may indicate a terminal node of a network, which performs communications directly with the terminal. Specific operations, which will be described as being performed by the base station in this specification, may be performed by an upper node of the base station.

That is, it is obvious that in a network comprising a plurality of network nodes including the base station, various operations performed for communications with the terminal can be performed by the base station or different network nodes other than the base station. ‘Base station’ will be replaced with other terms, such as a fixed station, Node B, eNode B (eNB), access point and the like. Also, ‘terminal’ may be replaced with other terms, such as user equipment (UE), mobile station (MS), mobile subscriber station (MSS) and the like.

The exemplary embodiment described herein may be embodied by various means. For example, the exemplary embodiments may be implemented by hardware, firmware, software, or combination of them.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, and micro-processors.

For firmware or software implementation, the method according the exemplary embodiments described herein may be implemented in the form of module, procedure, function or the like, which performs functions or operations described above. Software codes may be stored in a memory unit to be operated by a processor. The memory unit may be present inside or outside the processor, to exchange (transceiver) data with the processor via various means, which have been already known.

Specific terms used in the following description are provided for better understanding of the specification, and use of such terms may be changed into different forms within the scope of this invention.

### First Embodiment

A first embodiment of the present disclosure provides a method for receiving an emergency service message, in particular, an emergency alert message, while an idle mode terminal is maintained in an idle mode state.

FIG. 1 is a view showing a procedure for receiving an emergency alert message by a terminal according to an embodiment of the present invention of the present disclosure.

First, a terminal receives a control message including information indicating whether or not an emergency alert message has been transmitted in a paging available interval (S110). When the information indicates that an emergency alert message has been transmitted, the control message may further include information indicating a point in time at which the emergency alert message was transmitted.

The information indicating the point in time at which the emergency alert message was transmitted informs about a position of a superframe in which the emergency alert message was transmitted. The position of the superframe may be expressed by using an LSB (Least Significant Bit) or an LSB and an MSB (Most Significant Bit) of a superframe number. Namely, the emergency alert message is transmitted in a superframe corresponding to a bit value set in the LSB or the LSB and the MSB.

For example, when the information indicating the point in time at which the emergency alert message was transmitted is set to indicate that 4 bits of the LSB of a superframe number is ‘0’, the position of the superframe in which the emergency alert message was transmitted corresponds to a superframe in which 4 bits of the LSB of the superframe number is set to be ‘0’. Also, when 3 bits of the LSB of a superframe number is set to be ‘0’, a position of a superframe in which the emergency alert message corresponds to a superframe in which 3 bits of the LSB of a superframe number is set to be ‘0’.

Here, the position of the superframe may be informed by using both the LSB and the MSB according to the point in time at which the emergency alert message was transmitted.

The terminal may know the transmitted superframe number by checking the LSB or the LSB and the MSB of the superframe number included in a primary superframe header (P-SFH) transmitted in every superframe. Namely, the base station informs about the position of the superframe in which the emergency alert message was transmitted by using the LSB or the LSB and the MSB of the superframe number.

For example, the base station determines a transmission interval of the emergency alert message as a interval in which 4 bits of the LSB of the superframe number is set to be ‘0’, and transmits it to the terminal. In this case, the emergency alert message is transmitted in every interval in which 4 bits of the LSB of the superframe number is set to be ‘0’. Namely, the terminal may know the superframe number in which the emergency alert message was transmitted through a control message transmitted from the base station.

Here, the control message may be a paging advertisement message (AAI_PAG-ADV message).

Next, according to the results of checking the received control message, when the point in time at which the emergency service message was transmitted comes after the paging available interval, an idle mode state is maintained until before the emergency service message is received. Here, whether or not the point in time at which the emergency alert message was transmitted comes after the paging available interval can be known by comparing the LSB of the superframe number included in the superframe header received in the paging available interval with the information regarding the point in time at which the emergency alert message was transmitted.

Thus, although the terminal receives the information indicating the emergency alert message was transmitted in the paging available interval, if the point in time at which the emergency alert message was transmitted comes after the paging available interval, the terminal is maintained in a listening state only during the paging available interval, and when the paging available interval is terminated, the terminal is maintained in the idle mode state.

Next, the terminal receives a first message including a system parameter transmitted during a paging unavailable interval (S120). The first message may be a superframe header (SFH). The first message may be transmitted in every superframe, and include information indicating a superframe number in which the first message was transmitted. Namely, a position of the corresponding superframe may be known through the LSB of the superframe number included in the first message.

Namely, the terminal receives basic information of a system through the first message even during the paging unavailable interval. The system parameter includes LSB information of the superframe number.

Next, after the first message is received, the terminal compares whether or not the position of the superframe in which the first message is transmitted is identical to the position of the superframe in which the emergency alert message is transmitted. According to the comparison results, when the position of the superframe in which the first message is transmitted is not identical to the position of the superframe in which the emergency alert message is transmitted, the terminal is continuously maintained in the idle mode state.

However, according to the comparison results, when a point in time at which the first message was transmitted corresponds with the point in time at which the emergency alert message was transmitted, namely, when the LSB of the superframe number is identical, the terminal transitions from the current idle mode state to a wakeup state at a point in time at which the first message is received.

And then, in the state in which the terminal transitions to the wakeup state, the terminal receives an emergency alert message transmitted from the base station (S130). Here, the point in time at which the emergency alert message was transmitted may be a frame or a subframe in which the first message is transmitted.

Next, after the emergency alert message is received during the paging unavailable interval, the terminal transitions to a state before the wakeup, i.e., the idle mode state.

Here, when receives the emergency alert message in a state in which the terminal wakes up in the superframe in which the emergency alert message is transmitted, and after the superframe has passed, the terminal transitions to the idle mode state, a state before the wakeup, again.

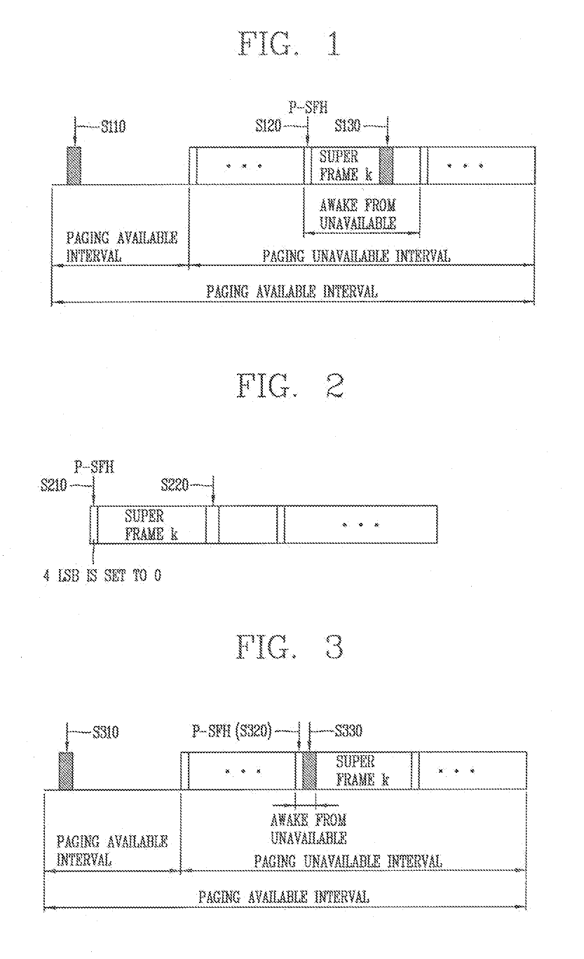

FIG. 2 is a view showing a method for transmitting an emergency alert message from a base station to a terminal according to a first embodiment of the present invention of the present disclosure.

First, the terminal transmits a control message including information indicating whether or not an emergency alert message is transmitted, to the terminal. The control message may be a paging advertisement message (AAI_PAG-ADV Message).

Here, when the base station generates the emergency alert message, the base station sets a bit value of the LSB or the LSB and MSB of a superframe number according to a period for transmitting the emergency alert message, namely, the point in time at which the emergency alert message was transmitted.

For example, when a transmission period of the emergency alert message is 320 ms, the base station sets 4 bits of the LSB of the superframe number as ‘0’ and transmits the emergency alert message in the corresponding superframe to the terminal. Here, one superframe is 20 ms, so 320 ms is equivalent to 16 superframes. Thus, the base station may determine the point in time at which the emergency alert message is transmitted whenever 4 bits of the LSB is set to be ‘0’. The 4 bits of the LSB may be set to be ‘1’, rather than ‘0’. In this case, the emergency alert message is transmitted in the superframe in which 4 bits of the LSB is set to be ‘1’.

In another example, when a period for transmitting the emergency alert message by the base station to the terminal is 160 ms, the emergency alert message is transmitted to the terminal whenever the 3 bits of the LSB of the superframe is set to be ‘0’. Namely, the LSB of the superframe is set according to a transmission period of the emergency alert message and the emergency alert message is transmitted in the corresponding set superframe.

If the transmission period of the emergency alert message transmitted to the terminal from the base station exceeds 320 nm, the LSB of the superframe number of the P-SFH is 4 bits, so it is impossible to fix the transmission period of the emergency alert message with only the 4 bits. Thus, when the period for transmitting the emergency alert message exceeds 320 ms, an additional bit may be set to be ‘0’ according to the period for transmitting the emergency alert message by also using the MSB bits of the superframe number of the S-SFH SP1 IE, as well as the LSB of the superframe number of the P-SFH.

Thus, when the emergency alert message is generated, the information regarding the point in time at which the emergency alert message was transmitted, namely, the bit value of the LSB or the LSB and MSB of the set superframe number, together with the information indicating that the emergency alert message was transmitted, is included in the control message and transmitted.

Thereafter, the base station transmits the P-SFH including the LSB of the corresponding superframe number to the terminal at every superframe during the paging unavailable interval (S210).

And then, the base station transmits the emergency alert message in the position of the set superframe (S220).

### Second Embodiment

The second embodiment of the present disclosure provides another method for receiving an emergency service message, in particular, the emergency alert message, while the terminal in the idle mode is maintained in the idle mode state.

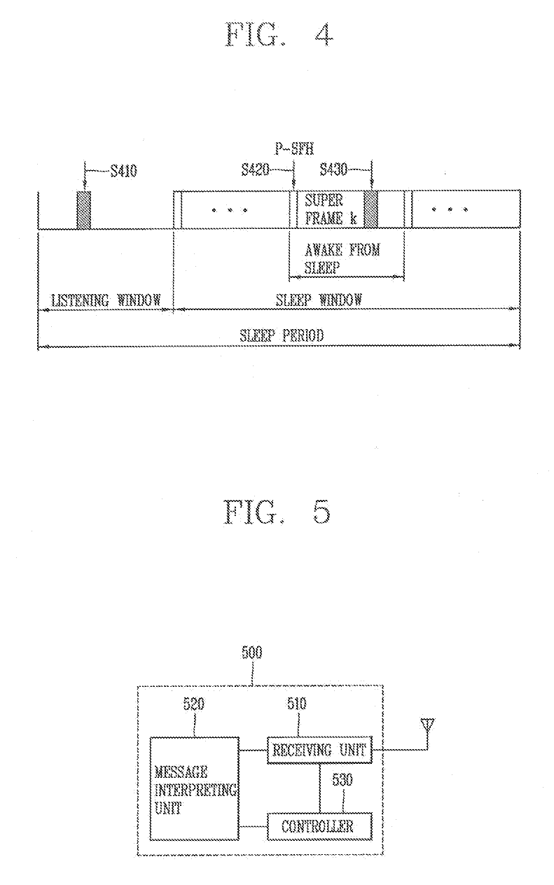

FIG. 3 is a view showing a procedure for receiving an emergency alert message by a terminal according to the second embodiment of the present invention of the present disclosure.

First, the process in which the terminal receives a control message including information regarding the point in time at which the emergency alert message was transmitted during a paging available interval, and transitions to a wakeup state at the point in time at which the emergency alert message was transmitted during a paging unavailable interval is the same as the operation of the terminal according to the first embodiment of the present invention, so a description thereof will be omitted (S310 to S330).

Next, in the state in which the terminal has transitioned to the wakeup state at the point in time at which the emergency alert message was transmitted, the terminal receives the emergency alert message transmitted from the base station. Here, the point in time at which the emergency alert message was transmitted corresponds to a subframe or a frame in which a first message is transmitted. Namely, when the first message is a P-SFH, the point in time at which the emergency alert message was transmitted corresponds to a subframe or a subframe in which the P-SFH is transmitted.

Next, after the emergency alert message is received, the terminal transitions to a state before the wakeup, namely, the idle mode state, again. Namely, the terminal wakes up during the corresponding superframe in which the emergency alert message was transmitted, receives the emergency alert message, and then, transitions to the idle mode state, rather than being maintained in the wakeup state during the super frame.

### Third Embodiment

A third embodiment of the present disclosure provides a method for receiving an emergency service message, in particular, an emergency alert message, while the terminal in a sleep mode is maintained in the sleep mode state.

FIG. 4 is a view showing a procedure for receiving an emergency alert message by a terminal according to the third embodiment of the present invention of the present disclosure.

First, the terminal receives a control message including information indicating whether or not an emergency alert message has been transmitted in a paging available interval (S410). When the information indicates that an emergency alert message has been transmitted, the control message may further include information indicating the point in time at which the emergency alert message was transmitted.

The information indicating the point in time at which the emergency alert message was transmitted informs about a position of a superframe in which the emergency alert message was transmitted. The position of the superframe may be expressed by using an LSB (Least Significant Bit) or an LSB and an MSB (Most Significant Bit) of a superframe number. Namely, the emergency alert message is transmitted in a superframe corresponding to a bit value set in the LSB or the LSB and the MSB.

For example, when the information indicating the point in time at which the emergency alert message was transmitted is set to indicate that 4 bits of the LSB of a superframe number is ‘0’, the position of the superframe in which the emergency alert message was transmitted corresponds to a superframe in which 4 bits of the LSB of the superframe number is set to be ‘0’. Also, when 3 bits of the LSB of a superframe number is set to be ‘0’, a position of a superframe in which the emergency alert message was transmitted corresponds to a superframe in which 3 bits of the LSB of a superframe number is set to be ‘0’.

Here, the position of the superframe may be informed by using both the LSB and the MSB according to the point in time at which the emergency alert message was transmitted.

The terminal may know the transmitted superframe number by checking the LSB or the LSB and the MSB of the superframe number included in a primary superframe header (P-SFH) transmitted in every superframe. Namely, the base station informs about the position of the superframe in which the emergency alert message by using the LSB or the LSB and the MSB of the superframe number.

For example, the base station determines a transmission interval of the emergency alert message as a interval in which 4 bits of the LSB of the superframe number is set to be ‘0’, and transmits it to the terminal. In this case, the emergency alert message is transmitted in every interval in which 4 bits of the LSB of the superframe number is set to be ‘0’. Namely, the terminal may know the superframe number in which the emergency alert message is transmitted through a control message transmitted from the base station.

Here, the control message may be a data traffic generation indication message (AAI_TRF-IND Message) or a sleep mode control extended header.

Next, according to the results of checking the received control message, when the point in time at which the emergency service message was transmitted comes after a listening interval (or a listening window), namely, comes in a sleep interval (or a sleep window), the sleep mode state is maintained until before the emergency service message is received. Here, whether or not the point in time at which the emergency alert message was transmitted comes after the listening interval can be known by comparing the LSB of the superframe number included in the superframe header received in the listening interval and the information regarding the point in time at which the emergency alert message was transmitted.

Thus, although the terminal receives the information indicating the emergency alert message was transmitted during the paging available interval, if the point in time at which the emergency alert message was transmitted comes after the paging available interval, the terminal is maintained in a listening state only during the paging available interval, and when the paging available interval is terminated, the terminal is maintained in the idle mode state.

Next, the terminal receives a first message including a system parameter transmitted during a sleep interval (S420). The first message may be a superframe header (SFH). The first message may be transmitted in every superframe, and include information indicating a superframe number in which the first message is transmitted. Namely, a position of the corresponding superframe may be known through the LSB of the superframe number included in the first message.

Namely, the terminal receives basic information of a system through the first message even during the sleep interval. The system parameter includes LSB information of the superframe number.

Next, after the first message is received, the terminal compares whether or not the position of the superframe in which the first message is transmitted is identical to the position of the superframe in which the emergency alert message is transmitted. According to the comparison results, when the position of the superframe in which the first message is transmitted is not identical to the position of the superframe in which the emergency alert message is transmitted, the terminal is continuously maintained in the idle mode state.

However, according to the comparison results, when a point in time at which the first message was transmitted corresponds with the point in time at which the emergency alert message was transmitted, namely, when the LSB of the superframe number is identical, the terminal transitions from the current idle mode state to a wakeup state at the point in time at which the first message is received.

And then, in the state in which the terminal transitions to the wakeup state, the terminal receives an emergency alert message transmitted from the base station (S430). Here, the point in time at which the emergency alert message was transmitted may be a frame or a subframe in which the first message is transmitted.

Next, after the emergency alert message is received during the sleep interval, the terminal transitions to a state before the wakeup, i.e., the sleep mode state.

Here, when receives the emergency alert message in a state in which the terminal wakes up in the superframe in which the emergency alert message is transmitted, and after the superframe has passed, the terminal transitions to the idle mode state, a state before the wakeup, again.

Also, when the point in time at which the emergency alert message was transmitted is a frame or a subframe in which the first message is transmitted, the terminal may receive the emergency alert message even during the corresponding superframe, and then transitions to the sleep mode state.

FIG. 5 is an internal block diagram of a terminal for receiving emergency alert information according to an embodiment of the present invention of the present disclosure.

A terminal 500 includes a receiving unit 510, a message interpreting unit 520, and a controller 530.

First, the receiving unit 510 receives a control message including information indicating that an emergency service message was transmitted in a paging available interval and information indicating a point in time at which the emergency service message was transmitted, and receives the emergence service message during a paging unavailable interval.

The control message may be a paging advertisement message. Also, the information indicating the point in time at which the emergency service message was transmitted may be information indicating a position of a superframe in which the emergency service message is transmitted, and the position of the superframe is determined according to a value set in the LSB of the superframe number.

The message interpreting unit 520 detects the point in time at which the emergency service message was transmitted and a point in time at which a first message including a system parameter was received from the received control message during a paging unavailable interval. Here, the system parameter includes an LBS of a superframe number in which the first message was transmitted.

The controller 530 determines whether or not the point in time at which the emergency service message was transmitted comes after the paging available interval, and controls the operation of the terminal. Here, when the point in time at which the emergency service message was transmitted comes after the paging available interval, the controller 530 controls the terminal to be maintained in the idle mode state until before the emergency service message is received.

Also, the controller compares the point in time at which the emergency service message was transmitted and the point in time at which the first message was received, and when they correspond with each other, the controller controls the terminal to transition to a wakeup state.

Here, the process of comparing whether or not the point in time at which the emergency service message was transmitted and point in time at which the first message was received correspond with each other may be performed by comparing the LSB of the superframe number included in the system parameter with point in time at which the emergency service message was transmitted.

1. A method for receiving an emergency service message of a terminal in an idle mode having a paging cycle comprised of a paging available interval and a paging unavailable interval, the method comprising:
receiving a control message including information indicating that an emergency service message was transmitted in the paging available interval and information indicating a point in time at which the emergency service message was transmitted;
when the point in time at which the emergency service message was transmitted comes after the paging available interval according to the results of checking the received control message, maintaining an idle mode state until before the emergency service message is received;
after a first message including a system parameter is received in the paging unavailable interval, comparing a point in time at which the first message was received and the point in time at which the emergency service message was transmitted to check whether or not they correspond with each other; and
when the points in time correspond with each other according to the comparison results, transitioning to a wakeup state from the point in time at which the first message was received, and receiving the emergency service message.

2. The method of claim 1, further comprising:
after the emergency service message is completely received, operating in the idle mode state before the wakeup.

3. The method of claim 1, wherein the first message is a primary super frame header (P-SFH).

4. The method of claim 1, wherein the information indicating the point in time at which the emergency service message was transmitted indicates a position of a superframe in which the emergency service message is transmitted, and the position of the superframe is determined according to a value set in a least significant bit (LSB) of a superframe number.

5. The method of claim 4, wherein the system parameter includes an LSB of the superframe number in which the first message is transmitted, and in the comparing, an LSB of the superframe included in the system parameter and a value set in an LSB indicating the point in time at which the emergency service message was indicated are compared to check whether or not they correspond with each other.

6. The method of claim 1, wherein the control message is a paging advertisement message (AAI_PAG-ADV Message).

7. The method of claim 2, wherein the position in which the emergency service message is transmitted is a subframe or a frame in which the first message is transmitted.

8. A method for receiving an emergency service message of a terminal in a sleep mode having a sleep cycle comprised of a listening window and a sleep window, the method comprising:
receiving a control message including information indicating that an emergency service message was transmitted in the listening window and information indicating a point in time at which the emergency service message was transmitted;
when the point in time at which the emergency service message was transmitted comes after the listening window according to the results of checking the received control message, maintaining a sleep mode state until before the emergency service message is received;
after a first message including a system parameter is received in the sleep window, comparing a point in time at which the first message was received and the point in time at which the emergency service message was received to check whether or not they correspond with each other; and
when the points in time correspond with each other according to the comparison results, transitioning to a wakeup state from the point in time at which the first message was received, and receiving the emergency service message.

9. The method of claim 8, wherein the control message is a data traffic generation indication message or a sleep mode control extended header.

10. A terminal for receiving an emergency service message in an idle mode having a paging cycle comprised of a paging available interval and a paging unavailable interval, the terminal comprising:
a receiving unit configured to receive a control message including information indicating that an emergency service message was transmitted in the paging available interval and information indicating a point in time at which the emergency service message was transmitted, and receive an emergency service message in the paging unavailable interval;
a message interpreting unit configured to detect the point in time at which the emergency service message was transmitted and a point in time at which a first message including a system parameter was received from the paging unavailable interval; and
a controller configured to control an operation of the terminal by determining whether or not the point in time at which the emergency service message was transmitted comes after the paging available interval.

11. The terminal of claim 10, wherein the controller compares the point in time at which the emergency service message was transmitted and the point in time at which the first message was received to check whether or not they correspond with each other, and when the points in time correspond with each other, the controller provides control to transition to a wakeup state.
